(19) United States
(12) Patent Application Publication
(10) Pub. No.: US 2016/0162156 A1
(43) Pub. Date: Jun. 9, 2016

(54) ELECTRONIC DEVICE AND METHOD FOR MANAGING DESKTOP ICONS

(71) Applicants: Fu Tai Hua Industry (Shenzhen) Co., Ltd., Shenzhen (CN); HON HAI PRECISION INDUSTRY CO., LTD., New Taipei (TW)

(72) Inventors: YA-LING LIU, Shenzhen (CN); CHIH-SAN CHIANG, New Taipei (TW); HAI-SEN LIANG, Shenzhen (CN); HAI-JUN MAO, Shenzhen (CN); TE-JIA LIU, Shenzhen (CN); TAO LIU, Shenzhen (CN)

(21) Appl. No.: 14/694,720

(22) Filed: Apr. 23, 2015

(30) Foreign Application Priority Data
Dec. 5, 2014 (CN) 201410737691.3

(51) Int. Cl. G06F 3/0481; G06F 3/0484; G06F 3/0482

(52) U.S. Cl. CPC G06F 3/04817; G06F 3/0482; G06F 3/04842

(57) ABSTRACT

In a desktop icon management method executed in an electronic device, icons are obtained from a storage device of the electronic device. Different icon categories are defined. The icons are classified in accordance with the icon categories. According to the icon categories, the icons are displayed on a desktop of the electronic device. A navigation pane is generated above the desktop. All the icon categories are displayed in the navigation pane. In response to an input via the navigation pane, an operation is performed to at least one of the icons in accordance with the input.

### CROSS-REFERENCE TO RELATED APPLICATIONS

This application claims priority to Chinese Patent Application No. 201410737691.3 filed on Dec. 5, 2014, the contents of which are incorporated by reference herein.

### FIELD

The subject matter herein generally relates to desktop management, and particularly to an electronic device and a method for managing desktop icons.

### BACKGROUND

Many icons may be disorderly displayed on a desktop of an electronic device, such as a personal computer. It is inconvenient for users to locate desired icons among all the icons on the desktop.

### BRIEF DESCRIPTION OF THE DRAWINGS

Implementations of the present technology will now be described, by way of example only, with reference to the attached figures.

FIG. 1 is a block diagram of one example embodiment of a hardware environment for executing a desktop icon management system.

FIG. 2 is a block diagram of one example embodiment of function modules of the desktop icon management system in FIG. 1.

FIG. 3 is a flowchart of one example embodiment of a desktop icon management method.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. The drawings are not necessarily to scale and the proportions of certain parts may be exaggerated to better illustrate details and features. The description is not to be considered as limiting the scope of the embodiments described herein.

Several definitions that apply throughout this disclosure will now be presented.

The term “module” refers to logic embodied in computing or firmware, or to a collection of software instructions, written in a programming language, such as, Java, C, or assembly. One or more software instructions in the modules may be embedded in firmware, such as in an erasable programmable read only memory (EPROM). The modules described herein may be implemented as either software and/or computing modules and may be stored in any type of non-transitory computer-readable medium or other storage device. Some non-limiting examples of non-transitory computer-readable media include CDs, DVDs, BLU-RAY, flash memory, and hard disk drives. The term “comprising” means “including, but not necessarily limited to”; it specifically indicates open-ended inclusion or membership in a so-described combination, group, series and the like.

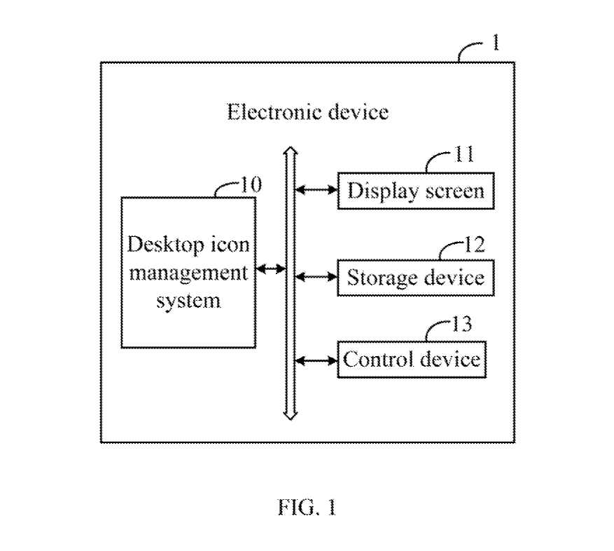

FIG. 1 is a block diagram of one example embodiment of a hardware environment for executing a desktop icon management system 10. The desktop icon management system 10 is installed in and run by an electronic device 1. The electronic device 1 can be a mobile phone, a TV, a personal computer, or a server. The electronic device 1 can include a display screen 11, a storage device 12, and at least one control device 13.

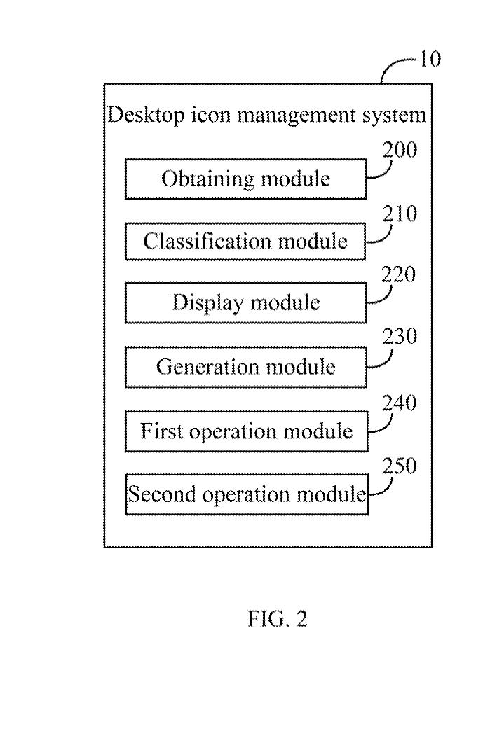

The desktop icon management system 10 can include a plurality of function modules (shown in FIG. 2) that manage icons on a desktop of the electronic device 1, to facilitate users to locate required icons. Each of the icons represents a file, an application, a webpage, or a computer command.

The display screen 11 is configured to display the desktop of the electronic device 1. In one embodiment, the display screen 11 can be a touch sensitive screen, a liquid crystal display (LCD) screen, or an organic light-emitting diode (OLED) display screen.

The storage device 12 can include some type(s) of non-transitory computer-readable storage medium such as, for example, a hard disk drive, a compact disc, a digital video disc, or a tape drive. The storage device 12 stores the computerized codes of the function modules of the desktop icon management system 10.

The control device 13 can be a processor, an application-specific integrated circuit (ASIC), or a field programmable gate array (FPGA), for example. The control device 13 can execute computerized codes of the function modules of the desktop icon management system 10 to realize the functions of the electronic device 1.

FIG. 2 is a block diagram of one embodiment of function modules of the desktop icon management system 10. The function modules can include, but are not limited to, an obtaining module 200, a classification module 210, a display module 220, a generation module 230, a first operation module 240, and a second operation module 250. The function modules 200-250 can include computerized codes in the form of one or more programs, which provide at least the functions of the desktop icon management system 10.

The obtaining module 200 is configured to obtain, from the storage device 12, icons to be displayed on the desktop of the electronic device 1. Each of the icons can represent a file, an application, a webpage, or a computer command. The icons can be set in the electronic device 1 by a user.

The classification module 210 is configured to define different icon categories, and classify the icons into the icon categories. Each of the icons can be classified into one of the icon categories. Each of the icon categories represents a type of icon. For example, the classification module 210 defines a first icon category, a second icon category, a third icon category, and a fourth icon category. The first icon category can include applications installed in the electronic device 1, such as calendar, calculator, and weather.

The display module 220 is configured to display the icons on the desktop of the electronic device 1 according to the icon categories of the icons. For example, the icons are classified into the first icon category, the second icon category, the third icon category, and the fourth icon category. The display module 220 displays icons classified into the first icon category at an upper left section of the desktop, displays icons classified into the second icon category at an upper right section of the desktop, displays icons classified into the third icon category at a lower left section of the desktop, and displays icons classified into the fourth icon category at a lower right section of the desktop. The display module 220 can display the icons in multiple desktop screens. For example, the display module 220 displays the icons in a first page and a second page of the desktop. The icons classified into the first icon category are displayed at an upper section of the first page, the icons classified into the second icon category are displayed at a lower section of the first page, the icons classified into the third icon category are displayed at an upper section of the second page, and the icons classified into the fourth icon category are displayed at a lower section of the second page.

The generation module 230 is configured to generate a navigation pane above the desktop, and display all the icon categories in the navigation pane. The navigation pane is smaller than the desktop. A layout of the icon categories in the navigation pane is same as the icon categories on the desktop. For example, the icons classified into the first icon category are displayed at the upper left section of the desktop, the icons classified into the second icon category are displayed at the upper right section of the desktop, the icons classified into the third icon category are displayed at the lower left section of the desktop, and the icons classified into the fourth icon category are displayed at the lower right section of the desktop. Correspondingly, the first icon category is displayed at an upper left section of the navigation pane, the second icon category is displayed at an upper right section of the navigation pane, the third icon category is displayed at a lower left section of the navigation pane, and the fourth icon category is displayed at a lower right section of the navigation pane. All the icon categories in the navigation pane represent a whole desktop display.

The generation module 230 can set a transparency of the navigation pane, and display the navigation pane according to the transparency.

The generation module 230 can display the navigation pane at any location of the display screen 11, such as a left part, a right part, an upper part, or a lower part of the display screen 11. The generation module 230 can set one or more buttons (such as a left shift button, a right shift button, an upper shift button, and a lower shift button) in the navigation pane for users to move the navigation pane on the display screen 11.

The generation module 230 can set a hide button in the navigation pane. When the hide button is clicked or touched by a user, the navigation pane is hidden. After the navigation pane is hidden, the generation module 230 can display a navigation icon representing the navigation pane above the desktop. When the navigation icon is clicked or touched by the user, the navigation pane is activated.

In one embodiment, the generation module 230 is further configured to display an icon number of each of the icon categories in the navigation pane. An icon number of an icon category denotes how many icons are included in the icon category. For example, an icon number of the first icon category is fourteen, indicating that fourteen icons are classified into the first icon category. An icon number of the second icon category is four, indicating that four icons are classified into the second icon category. An icon number of the third icon category is ten, indicating that ten icons are classified into the third icon category. An icon number of the fourth icon category is eight, indicating that eight icons are classified into the fourth icon category.

The generation module 230 can be further configured to mark a current display region of the desktop in the navigation pane. As mentioned above, all the icon categories displayed in the navigation pane represent the whole desktop display. Therefore, the current display region of the desktop marked in the navigation pane represents a location of a current display of the desktop in the whole desktop display. The generation module 230 can mark the current display region of the desktop in the navigation pane with a specific color (e.g., red) or a specific graphic (e.g., box).

The first operation module 240 is configured to receive an input via the navigation pane, and perform an operation to at least one of the icons in accordance with the input. In one embodiment, the input via the navigation pane is selecting an icon category in the navigation pane. In response to the selection, the first operation module 240 highlights all icons which are classified into the selected icon category, to facilitate the user viewing the icons classified into the selected icon category. In one embodiment, if the icons are displayed in multiple desktop screens, and the icons classified into the selected icon category are not in the current display region of the desktop, the first operation module 240 can display a different part of the desktop (such as cycle through the desktop screens) so that the icons classified into the selected icon category are displayed in the current display region of the desktop. The input via the navigation pane can be moving the icon categories in the navigation pane. When one icon category in the navigation pane is moved, the first operation module 240 moves all icons included in the moved icon category.

The second operation module 250 is configured to re-establish the current display region of the desktop in the navigation pane when the current display region of the desktop changes. For example, when the desktop screens are cycled through, or zoomed in and/or zoomed out by the user, resulting in a change of the current display region of the desktop, the second operation module 250 re-establishes the changed current display region of the desktop in the navigation pane.

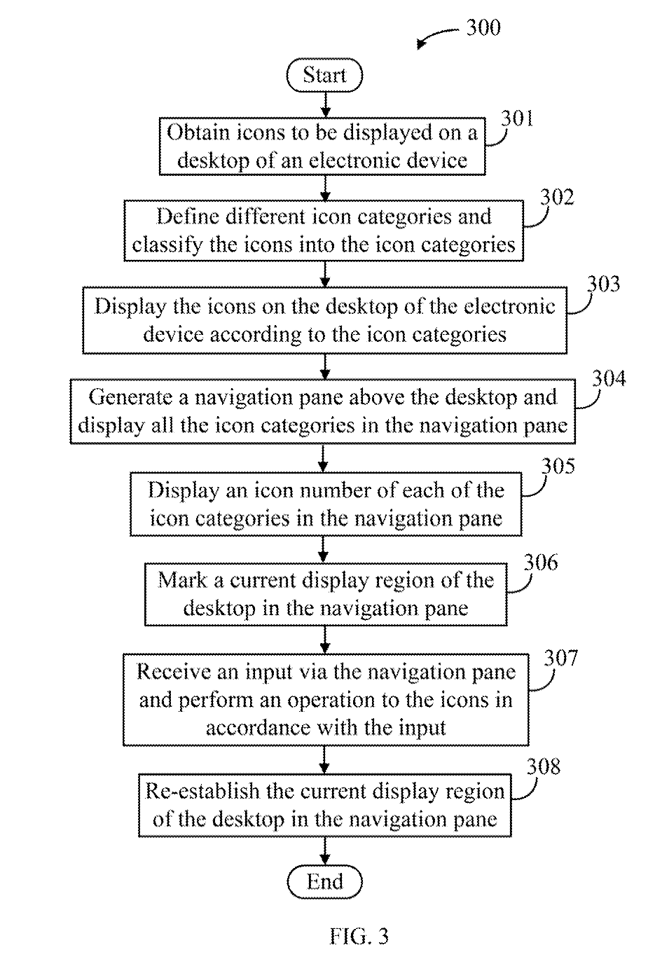

FIG. 3 is a flowchart of one example embodiment of a desktop icon management method. In the embodiment, the method is performed by execution of computer-readable software program codes or instructions by a control device, such as at least one processor of an electronic device. The electronic device includes a display screen and a storage device.

Referring to FIG. 3, a flowchart is presented in accordance with an example embodiment. The method 300 is provided by way of example, as there are a variety of ways to carry out the method. The method 300 described below can be carried out using the configurations illustrated in FIGS. 1-2, for example, and various elements of these figures are referenced in explaining method 300. Each block shown in FIG. 3 represents one or more processes, methods, or subroutines, carried out in the method 300. Furthermore, the illustrated order of blocks is illustrative only and the order of the blocks can be changed. Additional blocks can be added or fewer blocks may be utilized without departing from this disclosure. The method 300 can begin at block 301.

At block 301, an obtaining module obtains, from the storage device, icons to be displayed on a desktop of the electronic device. Each of the icons can represent a file, an application, a webpage, or a computer command. The icons can be set in the electronic device by a user.

At block 302, a classification module defines different icon categories, and classifies the icons into the icon categories. Each of the icons can be classified into one of the icon categories. Each of the icon categories represents a type of icon. For example, the classification module defines a first icon category, a second icon category, a third icon category, and a fourth icon category. The first icon category can include applications installed in the electronic device, such as calendar, calculator, and weather.

At block 303, a display module displays the icons on the desktop of the electronic device according to the icon categories of the icons. For example, the icons are classified into the first icon category, the second icon category, the third icon category, and the fourth icon category. The display module displays icons classified into the first icon category at an upper left section of the desktop, displays icons classified into the second icon category at an upper right section of the desktop, displays icons classified into the third icon category at a lower left section of the desktop, and displays icons classified into the fourth icon category at a lower right section of the desktop. The display module can display the icons in multiple desktop screens. For example, the display module displays the icons in a first page and a second page of the desktop. The icons classified into the first icon category are displayed at an upper section of the first page, the icons classified into the second icon category are displayed at a lower section of the first page, the icons classified into the third icon category are displayed at an upper section of the second page, and the icons classified into the fourth icon category are displayed at a lower section of the second page.

At block 304, a generation module generates a navigation pane above the desktop, and displays all the icon categories in the navigation pane. The navigation pane is smaller than the desktop. A layout of the icon categories in the navigation pane is same as the icon categories on the desktop. For example, the icons classified into the first icon category are displayed at the upper left section of the desktop, the icons classified into the second icon category are displayed at the upper right section of the desktop, the icons classified into the third icon category are displayed at the lower left section of the desktop, and the icons classified into the fourth icon category are displayed at the lower right section of the desktop. Correspondingly, the first icon category is displayed at an upper left section of the navigation pane, the second icon category is displayed at an upper right section of the navigation pane, the third icon category is displayed at a lower left section of the navigation pane, and the fourth icon category is displayed at a lower right section of the navigation pane. All the icon categories in the navigation pane represent a whole desktop display.

The generation module can set a transparency of the navigation pane, and display the navigation pane according to the transparency.

The generation module can display the navigation pane at any location of the display screen, such as a left part, a right part, an upper part, or a lower part of the display screen. The generation module can set one or more buttons (such as a left shift button, a right shift button, an upper shift button, and a lower shift button) in the navigation pane for users to move the navigation pane on the display screen.

The generation module can set a hide button in the navigation pane. When the hide button is clicked or pressed by a user, the navigation pane is hidden. After the navigation pane is hidden, the generation module can display a navigation icon representing the navigation pane above the desktop. When the navigation icon is clicked or pressed by the user, the navigation pane is activated.

At block 305, the generation module displays an icon number of each of the icon categories in the navigation pane. An icon number of an icon category denotes how many icons are included in the icon category. For example, an icon number of the first icon category is fourteen, indicating that fourteen icons are classified into the first icon category. An icon number of the second icon category is four, indicating that four icons are classified into the second icon category. An icon number of the third icon category is ten, indicating that ten icons are classified into the third icon category. An icon number of the fourth icon category is eight, indicating that eight icons are classified into the fourth icon category.

At block 306, the generation module marks a current display region of the desktop in the navigation pane. As mentioned above, all the icon categories in the navigation pane represent the whole desktop display. Therefore, the current display region of the desktop marked in the navigation pane represents a location of a current display of the desktop in the whole desktop display. The generation module can mark the current display region of the desktop in the navigation pane with a specific color (e.g., red) or a specific graphic (e.g., box).

At block 307, a first operation module receives an input via the navigation pane, and performs an operation to at least one of the icons in accordance with the input. In one embodiment, the input via the navigation pane is a selection of an icon category in the navigation pane. In response to the selection, the first operation module highlights all icons which are classified into the selected icon category, to facilitate the user viewing the icons classified into the selected icon category. In one embodiment, if the icons are displayed in multiple desktop screens, and the icons classified into the selected icon category are not in the current display region of the desktop, the first operation module can display a different part of the desktop (such as cycle through the desktop screens) so that the icons classified into the selected icon category are displayed in the current display region of the desktop. The input via the navigation pane can be moving the icon categories in the navigation pane. When one icon category in the navigation pane is moved, the first operation module moves all icons included in the moved icon category.

At block 308, a second operation module re-establishes the current display region of the desktop in the navigation pane when the current display region of the desktop changes. For example, when the desktop screens are cycled through, or zoomed in and/or zoomed out by the user, resulting in a change of the current display region of the desktop, the second operation module re-establishes the changed current display region of the desktop in the navigation pane.

The embodiments shown and described above are only examples. Even though numerous characteristics and advantages of the present technology have been set forth in the foregoing description, together with details of the structure and function of the present disclosure, the disclosure is illustrative only, and changes may be made in the detail, including in particular the matters of shape, size and arrangement of parts within the principles of the present disclosure, up to and including the full extent established by the broad general meaning of the terms used in the claims.

What is claimed is:

1. A desktop icon management method for an electronic device, the method comprising:
obtaining icons;
defining different icon categories, and classifying the icons in accordance with the icon categories;
displaying the icons on a desktop of the electronic device according to the icon categories;
generating a navigation pane above the desktop, and displaying all the icon categories in the navigation pane; and
receiving an input via the navigation pane, and performing an operation to at least one of the icons in accordance with the input.

2. The method according to claim 1, wherein the input via the navigation pane is a selection of an icon category in the navigation pane, and all icons classified into the selected icon category are highlighted in response to the selection.

3. The method according to claim 1, further comprising:
displaying an icon number of each of the icon categories in the navigation pane.

4. The method according to claim 1, further comprising:
marking a current display region of the desktop in the navigation pane.

5. The method according to claim 4, further comprising:
re-establishing the current display region of the desktop in the navigation pane when the current display region of the desktop changes.

6. An electronic device comprising:
a control device; and
a storage device storing one or more programs which when executed by the control device, causes the control device to perform operations comprising:
obtaining icons;
defining different icon categories, and classifying the icons in accordance with the icon categories;
displaying the icons on a desktop of the electronic device according to the icon categories;
generating a navigation pane above the desktop, and displaying all the icon categories in the navigation pane; and
receiving an input via the navigation pane, and performing an operation to at least one of the icons in accordance with the input.

7. The electronic device according to claim 6, wherein the input via the navigation pane is a selection of an icon category in the navigation pane, and all icons classified into the selected icon category are highlighted in response to the selection.

8. The electronic device according to claim 6, wherein the operations further comprise:
displaying an icon number of each of the icon categories in the navigation pane.

9. The electronic device according to claim 6, wherein the operations further comprise:
marking a current display region of the desktop in the navigation pane.

10. The electronic device according to claim 9, wherein the operations further comprise:
re-establishing the current display region of the desktop in the navigation pane when the current display region of the desktop changes.

11. A non-transitory storage medium having stored thereon instructions that, when executed by a control device of an electronic device, causes the control device to perform a desktop icon management method, the method comprising:
obtaining icons;
defining different icon categories, and classifying the icons in accordance with the icon categories;
displaying the icons on a desktop of the electronic device according to the icon categories;
generating a navigation pane above the desktop, and displaying all the icon categories in the navigation pane; and
receiving an input via the navigation pane, and performing an operation to at least one of the icons in accordance with the input.

12. The non-transitory storage medium according to claim 11, wherein the input via the navigation pane is a selection of an icon category in the navigation pane, and all icons classified into the selected icon category are highlighted in response to the selection.

13. The non-transitory storage medium according to claim 11, wherein the method further comprises:
displaying an icon number of each of the icon categories in the navigation pane.

14. The non-transitory storage medium according to claim 11, wherein the method further comprises:
marking a current display region of the desktop in the navigation pane.

15. The non-transitory storage medium according to claim 14, wherein the method further comprises:
re-establishing the current display region of the desktop in the navigation pane when the current display region of the desktop changes.
